(19) United States
(12) Patent Application Publication
(10) Pub. No.: US 2018/0339839 A1
(43) Pub. Date: Nov. 29, 2018

(54) THERMAL INSULATED SHIPPING CONTAINER

(71) Applicant: Princeton Packaging Inc., Sloatsburg, NY (US)

(72) Inventor: Jack BARATTA, Sloatsburg, NY (US)

(21) Appl. No.: 15/987,555

(22) Filed: May 23, 2018

Related U.S. Application Data
(60) Provisional application No. 62/510,323, filed on May 24, 2017.

(51) Int. Cl. B65D 81/38; B65D 5/62; B65D 5/02; B65D 81/05; B32B 1/02; B32B 29/08; B32B 3/30; B32B 7/12; B32B 15/12; B32B 15/085; B32B 27/32

(52) U.S. Cl. CPC B65D 81/3858; B32B 2307/304; B65D 5/0227; B65D 5/0236; B65D 81/052; B32B 1/02; B32B 29/08; B32B 3/30; B32B 7/12; B32B 15/12; B32B 15/085; B32B 27/32; B32B 2439/62; B32B 2307/56; B65D 5/62

(57) ABSTRACT

A method and system of and for transporting items, including an improved container having thermal isolation and/or insulation characteristics to maintain a desired temperature within the container, the container being lightweight, sturdy, and able to keep its contents well insulated.

### CROSS-REFERENCE TO RELATED APPLICATIONS

This application claims priority to U.S. Provisional Patent Application No. 62/510,323 entitled THERMAL INSULATED SHIPPING CONTAINER filed on May 24, 2017. The contents of this application are incorporated by reference in its entirety as if fully set forth herein.

### FIELD OF THE INVENTION

The present invention relates to shipping containers. More specifically, the present invention relates to packing and shipping containers comprising improved thermal insulation and/or isolation for maintaining a desired temperature therein.

### BACKGROUND OF THE INVENTION

Many and varied items require thermal protection during transport and shipping; such as but not limited to, perishable foods, pharmaceuticals, biologicals, botanicals, and the like. Known systems range in complexity and cost from simple Styrofoam® (expanded polystyrene) “picnic coolers” to electrically powered and computer controlled containers for transporting human organs for transplant. Many common systems include cooling items or systems such as dry ice, frozen gel packs, and the like.

Existing systems include: U.S. Pat. No. 2,575,893, U.S. Pat. No. 4,537,313, U.S. Pat. No. 4,730,748, U.S. Pat. No. 5,009,326, U.S. Pat. No. 5,820,268, U.S. Pat. No. 5,857,778, U.S. Pat. No. 6,513,974, U.S. Pat. No. 9,429,350, US20050224501, US20060202007, US20080276643 and US20090120829.

So-called picnic coolers are commonly used to temporarily hold and transport perishable foods and beverages, and are commercially available in various sizes and shapes. Such systems generally comprise walls defining an interior cavity, the walls usually including an insulating material, an insulative air or vacuum cavity, or combinations thereof. Such type coolers typically also require a coolant or cooling system; cubes or blocks of wet ice, dry ice, and/or freezable gel packs. Many times, such configurations are undesirable because any required cooling system is more bulky and heavier in weight than the item requiring thermal protective transport itself. Moreover, as shipping gross weight increases, so does associated shipping costs.

Cooled, chilled, or frozen items may be placed in a cooler alone, with no additional cooling system or cooling items provided. However, depending upon the thermal isolative and/or insulative capabilities of the cooler, such configurations typically maintain chilled or frozen items for less than twenty-four hours.

Another disadvantage of known thermal protective transport systems is internal condensation forming as the external environment changes during shipment. Moreover, during unpressurized or underpressurized air shipment realized dew-points may and do change quickly, possibly causing both internal and external condensation to form at various altitudes during flight. Many items requiring both thermal and condensation protection must also maintain a breathable atmosphere, such as botanicals; for example, live plants, cut flowers, or freshly harvested food stuffs.

Preferably, in the shipping and transportation industries, corrugated cardboard boxes of various thicknesses and sizes are typically utilized. Advantages of corrugated cardboard boxes include low expense and ease of manufacture; as well as ease of shipment and storage in a collapsed state after manufacture and before eventual use. Typically, just prior to and in preparation for use, corrugated cardboard shipping boxes are unfolded or expanded and secured with common polypropylene or polyester “shipping tape” or other securing system such as adhesives, metal or composite staples, etc.

Disadvantageously however, boxes made of corrugated cardboard alone provide little if any insulative and/or isolative thermal protection for shipped items. Expanded polystyrene has been utilized to provide additional thermal protection; but such insets must be pre-sized or cut-to-fit in specified dimensioned boxes and to contain specific items to be shipped, stored beforehand, and assembled and inserted into a matching corrugated box along with items being shipped and any required cooling system. Such labor and effort increases shipping costs overall.

Moreover, and most disadvantageously, modern computer controlled warehouse distribution centers using high-speed and high-volume packing systems typically utilize corrugated cardboard boxes of standard dimensions, sizes, and wall-thickness; thus prohibiting thermal insulation and/or isolation capable inserts being used without significant equipment modification or by initial intended equipment design.

It is desired to provide a method and system that solves the disadvantages in the prior art.

### SUMMARY OF THE INVENTION

An object of the instant invention is to provide a method and system of and for containing and transporting items which comprises a container having thermal isolation and/or insulation characteristics to maintain a desired temperature within the container.

An object of the instant invention is to provide a method and system of and for containing and transporting items, the method and system including a container having thermal isolation and/or insulation characteristics to maintain a desired temperature within the container, the container being lightweight, sturdy, and able to keep its contents well insulated.

An object of the instant invention is to provide a shipping container having an insulative layer within the shipping container and connected to the shipping container via a shock absorption layer.

An object of the instant invention is to provide a shipping container having thermal isolation and/or insulation characteristics and capable of being temporarily flattened and/or folded for ease of transport and storage.

An object of the instant invention is to provide a shipping container having thermal isolation and/or insulation characteristics and capable being used in and with automated packing and shipping systems.

These and other objects of the invention are achieved by a shipping container comprising: a housing including: a bottom wall and four side walls, the walls defining an interior compartment, a set of inner folding flaps connected to a top portion of at least two of the four side walls, and a set of outer folding flaps connected to a top portion of the other of the at least four side walls; and wherein the an exterior surface of the housing is made via corrugated cardboard, wherein an internal surface of the housing includes an interior insulative layer, wherein the set of inner folding flaps are configured to completely close the interior of the shipping container, and wherein the set of outer folding flaps are configured to encase the set of inner folding flaps.

In certain embodiments, the walls are assembleable to define an interior compartment and being disassembleable to lie flat.

In certain embodiments, the shipping container further comprises at least one insulation insert having at least one side, the insulation insert configured to be located within the interior of the housing.

In certain embodiments, the at least one insulation insert is configured to be folded into closed positions using inner or outer flaps oriented to close on the inside or the outside

In certain embodiments of the invention, the shipping container has the exterior surface of the housing that includes a waterproof coating.

In certain embodiments of the invention, the set of inner folding flaps form an airtight seal within the interior of the shipping container and wherein edges of the set of inner folding flaps are fused together via adhesive, tape, glue, heat gun, and combinations thereof

In certain embodiments of the invention, the shipping container is manufactured in various sizes and thickness.

In certain embodiments of the invention, the insulation insert is made of single- or double-sided bubble wrap.

In certain embodiments of the invention the insulation insert has flaps that are able to fold into and out of the shipping container.

In certain embodiments of the invention, the flaps are able to make an air tight/hermetic seal.

In certain embodiments of the invention, the insulation insert is permanently affixed to the corrugated cardboard via the shock absorption material or by other means.

In certain embodiments of the invention, the exterior surface of the container is waterproof.

In certain embodiments of the invention, the set of inner folding flaps have edges that are configured to meet one another to fully enclose the interior of the housing.

In certain embodiments of the invention, the set of outer folding flaps have edges that are configured to fully enclose the inner folding flaps.

In certain embodiments of the invention, the shipping container prevents heat transfer through the exterior of the shipping container.

Other objects of the invention are achieved by providing a shipping container described above; folding the inner folding flaps of the shipping container, so that the edges of the inner folding flaps touch and seal contents within an interior of the shipping container; and folding the outer folding flaps of the shipping container, so that the edges of the outer folding flaps touch one another to fully encase the inner folding flaps of the shipping container.

In certain embodiments of the invention, the edges of the inner folding flaps and the outer folding flaps are fused together via adhesive, tape, glue, heat gun, and combinations thereof.

In certain embodiments of the invention, providing at least one insulation insert and folding the insulation insert within the interior of the housing.

Other objects of the invention are achieved by providing a structural material to be folded into a container shape; further providing an insulating material for thermal isolation of the contents; manufacturing the structural and insulating material as one contiguous piece, which can be folded into the container shape.

In certain embodiments of the invention, a shock absorbing material is provided and affixed to the inside surface of the container.

In certain embodiments of the invention, a supplemental insert is manufactured to fit snugly within the shipping container with flaps that can be folded.

In certain embodiments of the invention, the structural material to be folded into the container shape is manufactured from waterproof material or with water proof material as the exterior surface.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic diagram of an embodiment of the inventive system and method comprising a corrugated cardboard shipping box including an insulative layer and a shock absorption layer.

FIG. 2 is a schematic diagram of an embodiment of the inventive system and method comprising a corrugated cardboard shipping box including an insulative layer and a shock absorption layer and secondary corrugated cardboard shipping insert prior to installation.

FIG. 3 is a schematic diagram of FIG. 1 with the secondary thermally insulated corrugated cardboard shipping insert located within the shipping box.

FIG. 4 is a schematic diagram of FIG. 1 comprising the corrugated cardboard shipping box in a partially closed position.

FIG. 5 is a schematic diagram of FIG. 1 comprising the corrugated cardboard shipping box in a fully closed position.

FIG. 6 is a cross section diagram of FIG. 1 comprising the corrugated cardboard shipping box, the thermal insulation, and the shock absorbing bubble wrap.

### DETAILED DESCRIPTION OF THE INVENTION

In the following description, numerous details are set forth for the purpose of explanation. However, one of ordinary skill in the art will realize that the invention may be practiced without the use of these specific details. For instance, the techniques described below are described in a specified order, but other embodiments may change the order of the operations while still embodying the current invention.

The invention is directed to a method and system of and for containing and transporting items which comprises a container having thermal isolation and/or insulation characteristics to maintain a desired temperature within the container.

In certain embodiments, the method and system are of and for containing and transporting items, the method and system including a container having thermal isolation and/or insulation characteristics to maintain a desired temperature within the container, the container being lightweight, sturdy, and able to keep its contents well insulated.

In certain embodiments, a shipping container having an insulative layer within the shipping container connected to the shipping container via a shock absorption layer is provided.

In certain embodiments, a shipping container has thermal isolation and/or insulation characteristics and capable of being flattened and/or folded for ease of transport and storage is provided.

In certain embodiments, a shipping container having thermal isolation and/or insulation characteristics and capable being used in and with automated packing and shipping systems is provided.

In certain embodiments of the invention, the insulative layer is made from a metallic material.

In certain embodiments of the invention, the shock absorption layer is bubble wrap or a material configured to and capable of absorbing shock.

In certain embodiments, the insulative layer prevents the transfer of heat across in insulative layer.

In certain embodiments, the air within the bubble wrap or material configured to and capable of absorbing shock is capable of having insulative properties and to prevent radiation from inside the container to outside the container.

In certain embodiments, the bubble wrap or material configured to and capable of absorbing shock controls heat transfer.

In certain embodiments, the insulative layer is configured to provide reflective insulation to able to keep heat in and reflect heat away.

In certain embodiments, the reflective insulation has the ability to control the transfer of radiant heat.

In certain embodiments, the reflective insulation has the ability to control radiation, conduction and convection.

In certain embodiments of the invention, the inside of the shipping container is completely covered by the shock absorption layer.

In certain embodiments of the invention, the shock absorption layer is completely covered by the insulative layer.

In certain embodiments of the invention, the shipping container includes two upper inner flap portions and two upper outer flap portions.

In certain embodiments of the invention, the two upper inner flap portions fold to have their edges meet one another to close the inner upper portion of the shipping container.

In certain embodiments of the invention, the two upper outer flap portions fold to have their edges meet one another to close the outer upper portion of the shipping container.

In certain embodiments of the invention, the closure of the two upper inner flap portions and the two upper outer flap portions provides an airtight seal to the shipping container.

In certain embodiments of the invention, the shipping container includes two lower inner flap portions and two lower outer flap portions.

In certain embodiments of the invention, the two lower inner flap portions fold to have their edges meet one another to close the inner lower portion of the shipping container.

In certain embodiments of the invention, the two lower outer flap portions fold to have their edges meet one another to close the lower portion of the shipping container.

In certain embodiments of the invention, the closure of the two lower inner flap portions and the two lower outer flap portions provides an airtight seal to the shipping container.

In certain embodiments of the invention, the shipping container provides the space advantages of a corrugated shipping box with the thermal advantages of a cooler.

In certain embodiments of the invention, the insulative layer has temperature transfer properties, such that heat is not able to easily pass through the insulative layer.

In certain embodiments of the invention, the shipping container further comprises a secondary insert, the secondary insert including an insulative layer and a shock absorption layer.

In certain embodiments of the invention, the secondary insert is configured to be placed within the shipping container.

In certain embodiments of the invention, the secondary insert provides additional support and insulation for the shipping container.

In certain embodiments of the invention, the insulative layer is affixed to the shock absorption layer via an adhesive. In certain embodiments, the adhesive is glue or another binding material. In certain embodiments, the insulative layer is affixed to the shock absorption layer via a heat gun.

In certain embodiments of the invention, the shock absorption layer is affixed to the inside of the shipping container via an adhesive.

In certain embodiments of the invention, the insulative layer is made from a metallic foil.

In certain embodiments, the insulative layer is made from a single bubble foil.

In certain embodiments, the insulative layer is made from a double bubble foil.

In certain embodiments, the double foil/foil insulation is constructed of a double layer of polyethylene bubble insulation bonded to two radiant barrier metalized sheets

In certain embodiments, the insulative layer is very thin ¼″- 5/16″, but has a high reflectivity, 96%, and a low emissivity, 4%; whereby only 4% of radiant heat passes through the insulative layer.

In certain embodiments of the invention, the insulative layer reflects radiant heat and works as a vapor barrier, preventing condensation which can cause mold.

In certain embodiments, the container is made of corrugated cardboard.

In certain embodiments, the insulative layer is affixed to the corrugated cardboard via an adhesive. In certain embodiments, the adhesive is glue or another binding material. In certain embodiments, the insulative layer is affixed to the shock absorption layer via a heat gun.

In certain embodiments, the corrugated cardboard has an outer coating that is waterproof or water resistant.

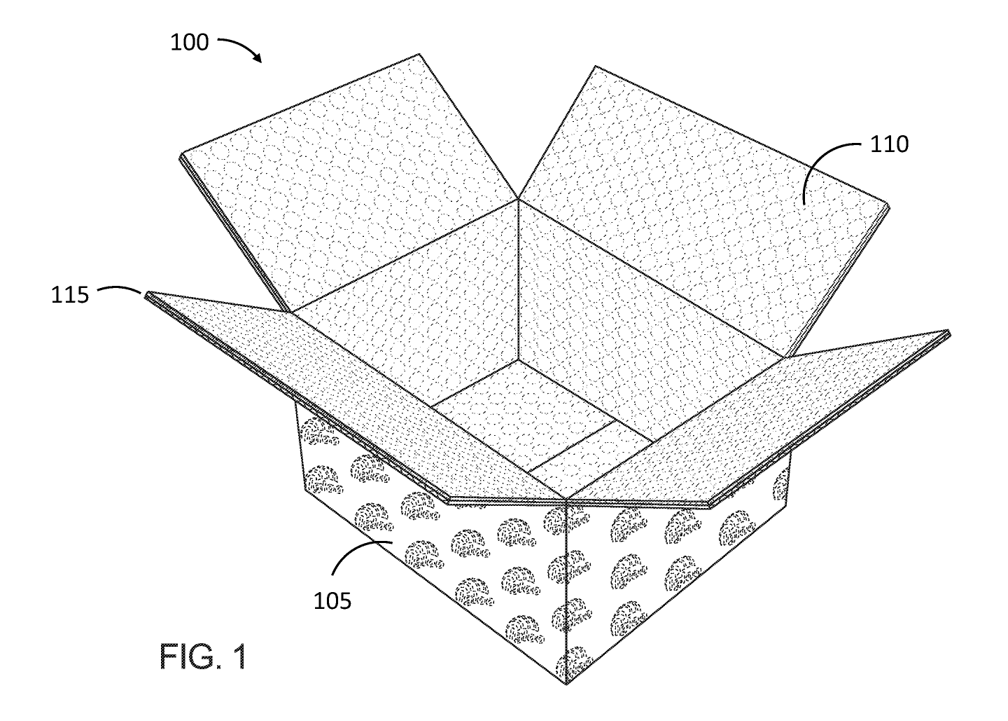

As depicted in FIG. 1, in an exemplary embodiment of the inventive thermal insulated packing and shipping container (100) comprising a corrugated cardboard shipping box (105) including an insulative layer (110) and a shock absorption layer (115).

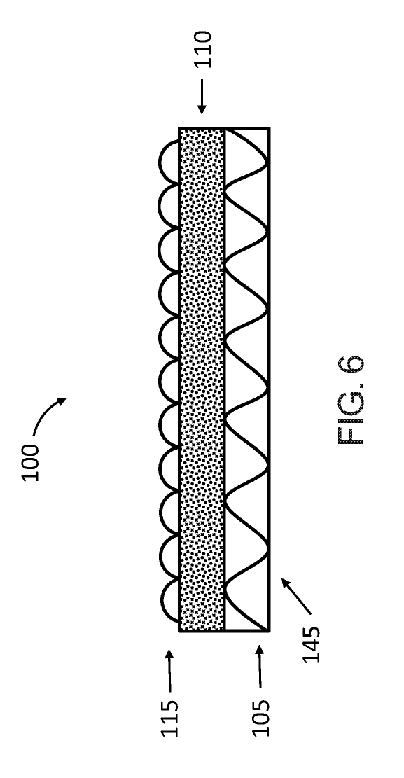

FIG. 6 shows a cross section of the thermal insulated packing and shipping container (100) showing the cardboard shipping box (105) including an insulative layer (110) and a shock absorption layer (115). Additionally a waterproof film and coating (145) can be attached to the cardboard shipping box (105).

Corrugated cardboard may consist of layers of brown kraft (sulfate) paper made from wood pulp and pressed into layers. Most commonly, corrugated cardboard includes three affixed layers of paper with a middle layer being “fluted” or “corrugated” in various configurations to provide desired added rigidity and strength. Typically, finished corrugated cardboard is die-cut as required for producing boxes of various sizes and dimensions.

In certain embodiments, the corrugated cardboard may be of a white color or may have an insulative outer coating such that the shipping container is water proof. In certain embodiments, the external surface of the shipping container contains a waterproof layer or film that is manufactured with the corrugated cardboard and prevents water from entering the shipping container.

It is contemplated in some embodiments of the inventive method and system that the insulative and shock absorption layers (110, 115) may be permanently secured to corrugated cardboard as a part of the cardboard manufacturing and layering process itself, and prior to the assembled corrugated cardboard (105), shock absorption layer (115), and insulative layer (110) combination being die-cut to size.

It is contemplated in some embodiments of the inventive method and system that the insulative and shock absorption layers (110, 115) may be permanently secured to corrugated cardboard after the cardboard manufacturing and layering process; that is, the shock absorption layer (115) and insulative layer (110) may be affixed to finished corrugated cardboard from another manufacturing source and then be die-cut to size.

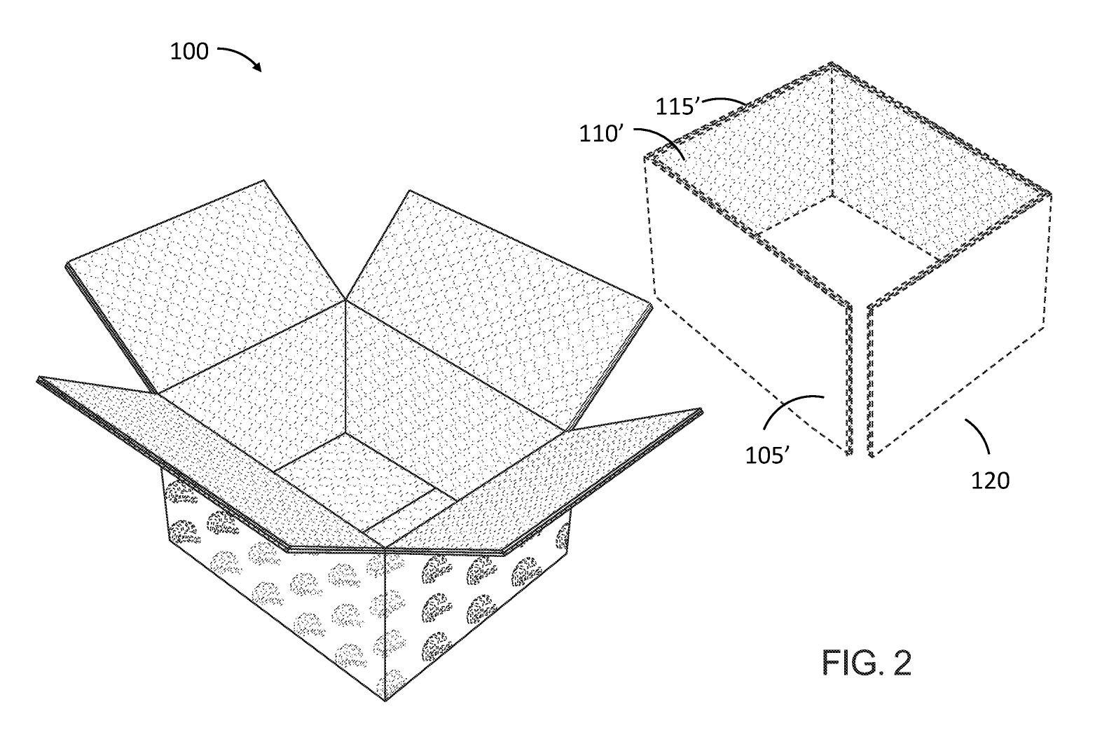

As depicted in FIG. 2, in an exemplary embodiment the inventive thermal insulated packing and shipping container (100) includes a secondary insert (120) comprising corrugated cardboard (105) an insulative layer (110) and a shock absorption layer (115) configured to be placed within the shipping container (100). It is contemplated that the secondary insert (120) may be of identical material as the inventive thermal insulated packing and shipping container (100). In certain embodiments, the secondary insert (120) includes the identical material as the inventive thermal insulated packing and shipping container (100), but for a waterproof outer film.

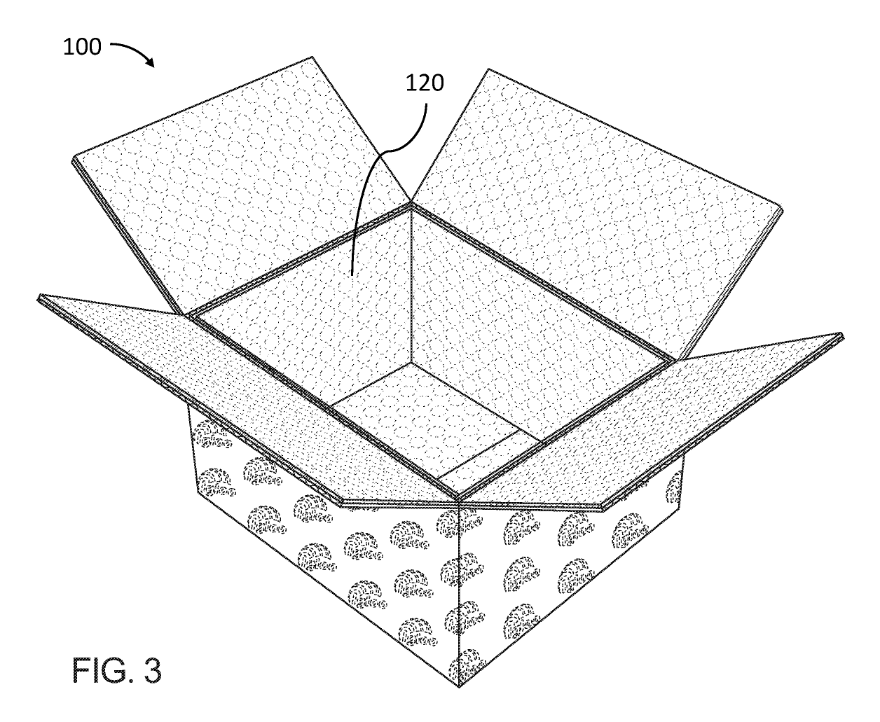

As depicted in FIG. 3-5, in an exemplary embodiment the inventive thermal insulated packing and shipping container (100) a secondary insert (120) comprising corrugated cardboard (105) an insulative layer (110) and a shock absorption layer (115) configured is placed within the shipping container (100) to provide additional and equal insulation and shock absorption once lower inner and outer portions, and upper inner portion (125) and upper outer portion (130) are closed and secured.

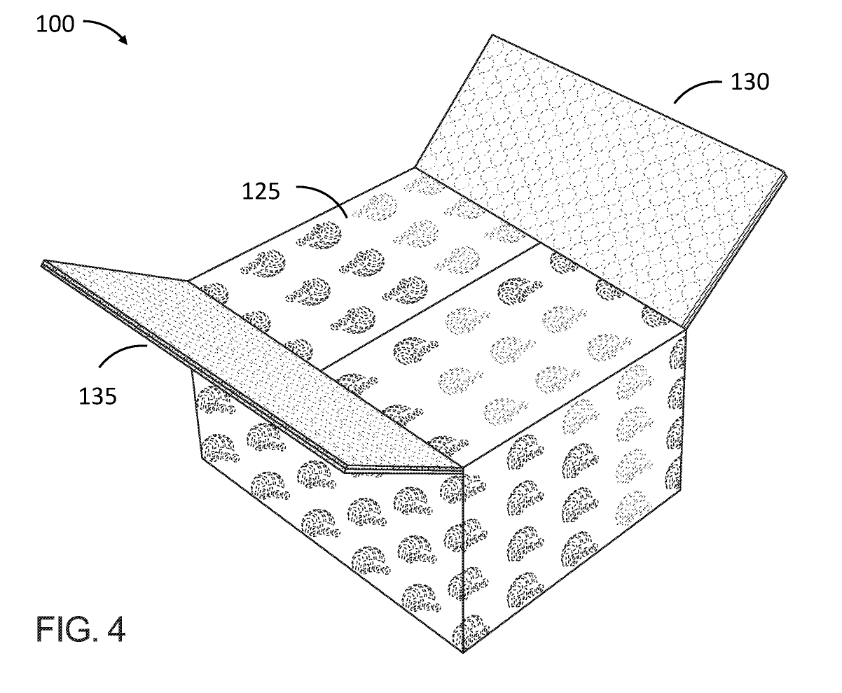

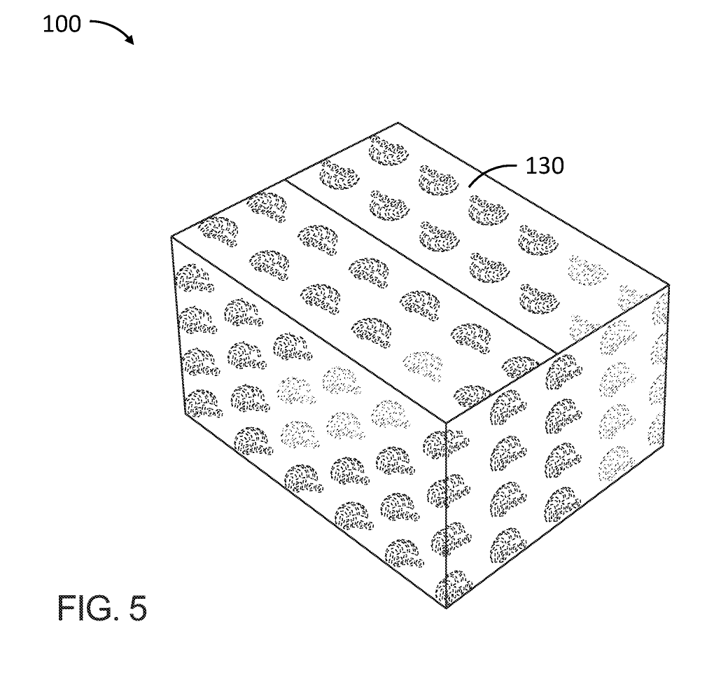

In FIG. 4, the shipping container (100) is shown having upper inner flaps (125) closed so the shipping container is in a partially closed position. The unclosed upper outer flaps (130) are shown and the embodiment with an adhesive lining the inner edge (135) of the upper outer flap is shown. In FIG. 5, the shipping container is shown having two upper outer flap portions (130) in a closed position.

Having the upper inner flaps (125) and upper outer flaps (130) shown having their edges touch one another is advantageous as this creates an airtight seal within the shipping container and maintains the insulative properties of the shipping container.

Additionally, in certain embodiments, adhesive or a tape material can be provided on the top of the upper inner flaps (125) such that when the two upper outer flap portions (130) are in a closed position, they are secured to the top of the upper inner flaps (125).

Having thus described several embodiments for practicing the inventive method, its advantages and objectives can be easily understood. Variations from the description above may and can be made by one skilled in the art without departing from the scope of the invention.

Accordingly, this invention is not to be limited by the embodiments as described, which are given by way of example only and not by way of limitation.

1. A shipping container comprising:
a housing including:
a bottom wall and four side walls defining an interior compartment,
a set of inner folding flaps connected to a top portion of at least two of the four side walls, and
a set of outer folding flaps connected to a top portion of the other of the at least four side walls;
wherein an exterior surface of the housing is made via corrugated cardboard,
wherein an internal surface of the housing includes an insulative layer,
wherein the set of inner folding flaps are configured to completely close the interior of the shipping container, and
wherein the set of outer folding flaps are configured to completely encase the set of inner folding flaps.

2. The shipping container of claim 1, further comprising at least one insulation insert having at least one side, the insulation insert configured to be placed within the interior of the housing.

3. The shipping container of claim 1, wherein the exterior surface of the housing includes a waterproof coating.

4. The shipping container of claim 1, wherein the set of inner folding flaps form an airtight seal within the interior of the shipping container and wherein edges of the set of inner folding flaps are fused together via adhesive, tape, glue, heat gun, and combinations thereof.

5. The shipping container of claim 1, wherein the shipping container is manufactured in various sizes and thickness.

6. The shipping container of claim 1, wherein the insulation insert is made of single- or double-sided bubble wrap.

7. The shipping container of claim 1, wherein the insulation insert has flaps that are able to fold into and out of the shipping container.

8. The shipping container of claim 1, wherein the set of outer folding flaps form an airtight seal within the interior of the shipping container.

9. The shipping container of claim 1, wherein the insulation insert is permanently affixed to the corrugated cardboard via the shock absorption material.

10. The shipping container of claim 1, wherein the set of inner folding flaps have edges that are configured to meet one another to fully enclose the interior of the housing.

11. The shipping container of claim 1, wherein the set of outer folding flaps have edges that are configured to meet one another.

12. The shipping container of claim 1, wherein the shipping container prevents heat transfer through the exterior of the shipping container.

13. A method for containing and transporting items, comprising:
providing a shipping container according to claim 1;
folding the inner folding flaps of the shipping container, so that the edges of the inner folding flaps touch and seal contents within an interior of the shipping container; and
folding the outer folding flaps of the shipping container, so that the edges of the outer folding flaps touch one another to fully encase the inner folding flaps of the shipping container.

14. The method of claim 13, wherein the edges of the inner folding flaps and the outer folding flaps are fused together via adhesive, tape, glue, heat gun, and combinations thereof.

15. The method of claim 13, further comprising providing at least one insulation insert and folding the insulation insert within the interior of the housing.

16. A method for manufacturing the thermally insulated shipping container of claim 1, the method comprising the steps of:
providing a structural material to be folded into a container shape;
providing an insulating material for thermal isolation of the contents;
manufacturing the structural material and the insulating material as one contiguous piece, which can be folded into the container shape.

17. The method of claim 16, further comprising providing a shock absorbing material and affixing the shock absorbing material to the inside surface of the container.

18. The method of claim 16, further comprising providing a supplemental insert and fitting the supplemental insert within the shipping container with flaps that can be folded.

19. The method of claim 16, wherein the structural material to be folded into the container shape is manufactured from waterproof material or with water proof material as the exterior surface.
